(19) United States
(12) Patent Application Publication
(10) Pub. No.: US 2024/0149750 A1
(43) Pub. Date: May 9, 2024

(54) METHOD FOR OPERATING A FUEL CELL SYSTEM OF A UTILITY VEHICLE

(71) Applicant: ZF CV Systems Global GmbH, Bern (CH)

(72) Inventor: Janik Ricke, Uetze (DE)

(21) Appl. No.: 18/413,201

(22) Filed: Jan. 16, 2024

Related U.S. Application Data
(63) Continuation of application No. PCT/EP2022/068571, filed on Jul. 5, 2022.

(30) Foreign Application Priority Data
Jul. 16, 2021 (DE) 10 2021 118 439.8

(51) Int. Cl. B60L 58/31; B60L 58/33; H01M 8/04302

(52) U.S. Cl. CPC B60L 58/31; B60L 58/33; H01M 8/04302; H01M 2250/20

(57) ABSTRACT

A method for operating a fuel cell system of a utility vehicle over multiple journeys includes: actuating a compressor arrangement that has a plurality of compressors such that pressurized air is provided, and supplying the pressurized air to the fuel cell system on the cathode side. The actuation includes: selecting a number and/or sequence of compressors from the plurality of compressors to be actuated for the journeys such that the selection of the number and/or sequence differs at least for two consecutive journeys of the utility vehicle. Further, a fuel cell system is able to be operated in this manner. A control unit and a computer program product can also be configured to operate a fuel cell system of a utility vehicle over multiple journeys.

### CROSS-REFERENCE TO RELATED APPLICATIONS

This application is a continuation application of international patent application PCT/EP2022/068571, filed Jul. 5, 2022, designating the United States and claiming priority from German application 10 2021 118 439.8, filed Jul. 16, 2021, and the entire content of both applications is incorporated herein by reference.

### TECHNICAL FIELD

The disclosure relates to a method for operating a fuel cell system of a utility vehicle over multiple journeys, including the steps of actuating a compressor arrangement that has a plurality of compressors such that pressurized air is provided, and of supplying the pressurized air to the fuel cell system on the cathode side.

### BACKGROUND

The provision of pressurized air for the fuel cell system is critical for the efficient operation of the utility vehicle. The compressor arrangements used for this purpose are inevitably subject to a certain degree of wear due to their long service lives. It has been recognized that systems used in utility vehicles have increased requirements placed on them in terms of service life compared to requirements placed on systems from passenger cars.

The prior art discloses fuel cell systems that use more than one compressor. In such systems, coordination of the operation of multiple compressors within a compressor arrangement has to date been configured exclusively for supplying the fuel cell system with an optimum amount of air. Service life considerations have to date not played any role in such systems for the compressor arrangements and the coordination thereof during operation.

By way of example, US 2010/0273079 discloses a scaled fuel cell system including multiple stacks within the fuel cell system, which also has multiple compressors.

DE 102016224721 A1 discloses an arrangement of series-connected compressors for a fuel cell system for passenger cars. DE 102011114720 A1 also discloses a fuel cell system including an air supply arrangement consisting of two series-connected compressor stages.

DE 10201502088 A1 discusses a fuel cell system including multiple parallel-connected compressors, in which a first compressor is always operated, and a second compressor is able to be connected in as what is known as a booster for the short-term provision of additional pressurized air.

DE 102018214710 A1 describes a fuel cell device having two parallel-connected compressors of asymmetrical configuration that are actuated so as to operate the fuel cell system at its optimum operating point.

It is an object of the disclosure to improve the operation of fuel cells such that the disadvantages described above are overcome as far as possible. In particular, the object of the disclosure was to improve the operation of fuel cell systems such that the service life of the compressor arrangement is increased, and the systems may accordingly be configured to be more maintenance-friendly.

To this end, the disclosure proposes for the actuation to include selecting a number and/or sequence of compressors from the plurality of compressors to be actuated for the journeys such that the selection of the number and/or sequence differs at least for two consecutive journeys of the utility vehicle.

“Consecutive” should be understood to mean two consecutive journeys from the plurality of journeys. In the context of the disclosure, a number of compressors should be understood to mean an arrangement of one or more compressors. Selecting a number of compressors thus includes selecting in each case a specific compressor, and also selecting a group of compressors from the plurality of compressors, wherein the number of compressors may be the plurality of compressors. The smaller the number of selected compressors relative to the plurality of compressors, the more significant the aspect of service life optimization will be.

The disclosure is based on the finding that, in particular when starting and stopping the compressors, a particularly large amount of wear occurs because, in the bearing arrangements, especially in air bearings, friction occurs between the plain bearing partners and decreases significantly or no longer occurs only after a critical lift-off speed is reached. The disclosure takes this as a starting point and aims, by individually selecting the number and/or sequence for consecutive journeys, to minimize the number of starting operations of compressors for the journeys of the utility vehicle as far as possible. The operating strategy proposed by the disclosure aims to drive as few compressors as possible for a journey of the utility vehicle, and also aims to distribute the load on the compressors over multiple journeys as evenly as possible, so that the compressors within the compressor arrangement are able to progress through their life cycle or maintenance cycle as evenly as possible.

An advantage of the disclosure already occurs when the number and/or sequence of the compressors within the compressor arrangement is not the same for each journey, that is, when only occasionally a different compressor, a different number of compressors, or another sequence, that is, time sequence, of the actuated compressors is or are selected for consecutive journeys. It is by all means generally permissible, within the context of the disclosure, to actuate the same number and/or sequence of compressors within the compressor arrangement for a limited number of journeys, and then to change this number and/or sequence through appropriate selection, and then to undertake further journeys with the vehicle again for a limited number of journeys with that number and/or sequence of compressors.

In an embodiment, the number and/or sequence of selected compressors always differs for two consecutive journeys of the utility vehicle. The advantages described above come to the fore to an even greater extent the more often a number of compressors different from the respective previous state and/or a modified sequence of the actuated compressors is selected. Preferably, different compressors are selected to be actuated for each journey in order to ensure the most uniform possible accumulation of actuations for the compressors.

The number and/or sequence of the selected compressors may be varied deterministically, for example, in particular in a predetermined, for example cyclic sequence, or according to the random principle, wherein particularly preferably those compressors that were actuated in an immediately preceding journey are blocked from selection for the following journey. In a fuel cell system including a compressor arrangement consisting of two compressors, for example, alternating operation of the compressors from the compressor arrangement would be advantageous and very easy to implement from a control engineering point of view.

In a further embodiment, the method includes the following step: retrieving one or more control parameters stored in a data memory, wherein the selection is made on the basis of the one or more control parameters. As an alternative or in addition to the deterministic selection of the number of compressors from the compressor arrangement as described further above, control parameters may also be used as decision criteria for selecting the compressors at the start of the journey, these control parameters having been stored beforehand in a data memory. Storage in the data memory may be carried out in a first initialization step, for example ex works, and may also be updated during ongoing operation of the utility vehicle or of the fuel cell system by feeding in updated control parameters. By way of example, it is possible for example to use system information in relation to the fuel cell system, or information from the fleet management system of the utility vehicle, and also information about the operating history of the compressors themselves as control parameters. Particularly preferred control parameters will be discussed below.

In a further embodiment, the one or more control parameters includes or include historical data from the compressors in the compressor arrangement. Historical data are understood to mean information about the operating history of the compressors, which in other words characterizes the “operating age” of the compressors. The historical data from the compressors are easy to determine and allow a reliable estimate of the ageing or progressive wear of the compressors.

According to a further embodiment, the historical data represent one, several or all of the following types of information:
accumulated operating time of the compressors,
accumulated number of start-up cycles of the compressors,
accumulated number of compressor shaft rotations of the compressors,
time of last previous commissioning of the compressors,
ambient temperature in previous actuations,
number of load changes in previous actuations,
accumulated operating time of the compressors in the upper load range, or
a combination of several or all of the above parameters.

Selecting the historical data easily makes it possible, during a journey, to operate as a priority in each case those compressors that have accumulated a low operating time compared to other compressors from the compressor arrangement or that have undergone a small number of start-up cycles and the like, which suggests low wear relative to the other compressors of the compressor arrangement. It has also been recognized that the wear during the compressor start phase is higher the lower the ambient temperature. Preferably, the temperature values in the historical data are used to weight those actuations of compressors to a greater extent the lower the ambient temperature was during the actuation, in order to avoid premature wear for these compressors relative to those compressors that tended to be used at higher temperatures. It has likewise been recognized that the previous number of load changes is a wear indicator for the compressors. If a compressor is operated with fast and/or a large number of load changes, its wear is greater than in constant operation. As an alternative or in addition, therefore, those actuations of compressors are preferably weighted to a greater extent in the historical data the higher the number and/or severity of load changes was during the actuation, in order to avoid premature wear for these compressors relative to those compressors that tended to be actuated with less load change. The upper load range is preferably understood here to mean operation in the upper third, quarter or fifth. It has been recognized that the compressors, in addition to simple operating time, are also subjected to greater wear the longer they are loaded in their upper load range. As an alternative or in addition, therefore, those actuations of compressors are preferably weighted to a greater extent in the historical data the more operating time the compressors have been operated in their upper load range, in order to avoid premature wear for these compressors relative to those compressors that tended to be actuated at lower load.

In a further embodiment, the one or more control parameters, as an alternative or in addition, include performance data, and in particular represent one, several or all of the following types of information:
optimum operating point of the compressors,
mass of the utility vehicle,
route length of the journeys,
route topography of the journeys,
total storage capacity of the electrical storage unit of the utility vehicle,
state of charge of the electrical storage unit of the utility vehicle, or
a combination of several or all of the above parameters.

As an alternative or in addition to the use of control parameters that concern the operating history of the compressors, it is also possible to make the selection of the number of compressors from the compressor arrangement dependent on how much power is actually required by the fuel cell system in the form of pressurized air, when this power is required, and how much power the respective compressors are able to provide in the form of pressurized air. Within the context of the disclosure, an optimum operating point of the compressors is understood to mean that operating point of the compressor at which it achieves its highest efficiency. Within the context of the disclosure, the highest efficiency should be understood to mean that operating point at which the compressor provides the best ratio between electric power consumption and achieved compression performance. The inventors have recognized that, during operation of a utility vehicle, there may be considerable fluctuations in the overall mass of the vehicle system between two journeys because, during actual operation, the utility vehicle does not always undertake journeys with a full load, but rather always also undertakes empty journeys. During an empty journey, in contrast to passenger cars, the mass of the overall system of the utility vehicle is significantly lower than in the loaded state, with this aspect having a greater effect the greater the maximum payload of the utility vehicle. The disclosure takes this as a starting point by reading in the mass of the utility vehicle, which is present in the electronic system of the utility vehicle, or by storing it in the data memory and using it as a criterion for selecting the compressors. It is therefore possible, in the case of a low vehicle mass, that is, an empty vehicle, to take a journey with just a single compressor, for example, and to use multiple compressors only when the utility vehicle has to undertake a journey in the loaded state.

Likewise, depending on the route length of a journey, for example, a sequencing of the operation of the compressors within the compressor arrangement in which the compressors are operated alternately is conceivable. The information about the route length of a journey may be determined for example using the fleet management system or using route topography information known in the navigation system of the utility vehicle.

The same applies to the route topography of a journey: More electric power is required on route sections with ascents, and more pressurized air has to be supplied to the cathode side in the fuel cell system as a result. According to the disclosure, it is possible in such cases to actuate additional compressors in a targeted manner in order to provide more air, but also at the same time to continue the operating strategy concept, namely not to operate the same combination of compressors on each ascent, but also here to generate a variation in the selection of the number and/or sequence of compressors through a sequencing for consecutive journeys or consecutive ascents within the journey.

In addition, if information about the storage capacity of the electrical storage unit of the utility vehicle and/or the currently available amount of stored electrical energy is known as performance data, this information may be used, in combination with the route information and where applicable other vehicle data, for a forecast as to when one or more further compressors should be actuated or may stop being actuated.

In a further embodiment, the one or more control parameters, as an alternative or in addition, include temperature data, and in particular represent information about the operating temperature of a cooling system of the compressors. This makes it possible to further reduce the wear of those compressors that are not actuated first in a selection sequence by heating these compressors that are to be actuated later to operating temperature even before they are started. A cold start is thus prevented for such compressors. Only those compressors or that number of compressors that are initially selected at the start of the journey are then subjected to the cold start, which further contributes as a whole to extending the service life of the compressor arrangement. Preferably, only those compressors within the compressor arrangement that have already reached operating temperature are selected, wherein compressors that have not yet reached operating temperature are blocked from selection at actuation or at least less highly prioritized than compressors that have already been brought to operating temperature.

In a further embodiment of the method, a first number of compressors, preferably a single compressor, is first actuated at the start of a journey. The restriction to a single compressor for the initial actuation is in keeping with the finding that it is already possible to use this single compressor to provide enough pressurized air to the fuel cell system, at least for the start of the journey. This single compressor may already take on valuable support tasks in order to minimize the wear of any compressor to be connected in later, for example heating a common cooling system used by multiple compressors.

Preferably, one or more further compressors are additionally actuated during the journey following actuation of the first number of compressors, in particular on the basis of one or more of the control parameters. As a guiding principle, in the method according to the disclosure, a smallest possible number of compressors are actuated during the journey where possible, since the best possible protection of the compressors is ensured when it is possible to prevent a start and/or stop cycle.

In an embodiment, the compressors actuated at the start of each journey differ in consecutive journeys. As described above, this achieves uniform ageing of the compressors with potentially low programming effort.

In a further embodiment, at least some of the air compressed by the first number of compressors is supplied to an air bearing arrangement of one or more of the further compressors, in particular before the further compressors are actuated. This embodiment achieves a further service life-optimizing support function that is performed by the initially actuated number of compressors for the compressors to be connected in somewhat later. The pressurized air that is provided may also be used, in addition to supplying compressed air to the fuel system, to support the air bearing arrangement of one or more compressors. The injection of air into the bearing gap of the air bearings aids faster lift-off of the rotor shaft of the compressors and accordingly minimizes wear when the compressors are started up. In addition, the air is already heated after passing through the first compressor. Supplying this heated air to the one or more further compressors means that these are preheated at least to a certain extent at the same time. This preheating may be applied as an alternative or in addition to a dedicated cooling or heating system. The bearing points in particular benefit from such heating because they are among the most wear-prone components in the compressor.

In a further embodiment, the method includes the following step: continuing to actuate the compressors, preferably while adjusting the load points of the compressors, during the journeys, even if the amount of air required by the fuel cell system decreases. Continuing to actuate the compressors should be understood, according to the disclosure, to mean that the compressors continue to be kept up to speed, preferably at a speed above the lift-off speed, so that the compressor shafts continue to rotate without wear. As long as the fuel cell is provided with an amount of air sufficient for it to operate or adapted to the optimum operating point, there is no harm in letting the compressors operate themselves at an operating point that is below the optimum operating point, at least as long as a predetermined threshold value for the efficiency of the compressors is still reached. This embodiment expresses the concept that wear occurs in the compressor not only when starting, but also when standstill is reached after the lift-off speed has been fallen below. If possible, therefore, in this embodiment, the compressors may continue to be kept in rotation, even if they would strictly speaking no longer be required by the fuel cell system to meet the power demand, and the required compressed air could also be provided on the cathode side by a smaller number of compressors. Preferably, such operation with an increased number of compressors takes place over a limited period of time that is determined depending on the efficiency at which the increased number of compressors is operated. The poorer the efficiency of the compressors, the more the maximum time interval for such an operating mode is preferably limited.

The disclosure basically follows the maxim here that, on the one hand, as few compressors as possible are put into operation during a journey, but also, at the same time, as few compressors as possible, once put into operation, are taken out of operation during a journey.

The actuation of the compressors is preferably continued as long as the efficiency of the respective operational arrangement consisting of compressor, electric motor and power electronics, in particular inverter, remains above a predetermined threshold value. Preferably, the threshold value for the efficiency is 40% or more, more preferably 45% or more, and particularly preferably 50% or more.

The disclosure has been described above in a first aspect with reference to the method. In a second aspect, the disclosure also relates to a utility vehicle fuel cell system, including a fuel cell, a compressor arrangement that is connected to the fuel cell in a fluid-conducting manner, that has a plurality of compressors and that is configured to provide pressurized air to the fuel cell on the cathode side, and a control unit that is connected to the compressor arrangement in a signal-carrying manner and is configured to actuate the compressors of the compressor arrangement.

The disclosure achieves the object described at the outset in such a system by virtue of the control unit being configured to carry out the method according to one of the embodiments described above. The disclosure in this regard utilizes the same advantages as the method according to the disclosure. Embodiments of the method according to the disclosure are therefore at the same time embodiments of the fuel cell system and vice versa, and therefore reference is made to the above explanations in order to avoid repetitions.

In an embodiment, the compressors are connected at least partially in parallel within the compressor arrangement. More preferably, the fuel cell system has multiple groups of compressors, wherein the compressors within a group are each connected in series or in parallel, and wherein the different groups of compressors are connected in parallel. More preferably, all of the compressors of the compressor arrangement are connected in parallel. The parallel connection makes it possible to ensure the best possible protection of the inactive compressors because the pressurized air provided by the respectively actuated compressor does not have to flow through the flow path of the compressors to be protected.

In a further embodiment, the compressor arrangement has a cooling system, which may be a liquid cooling system or an air cooling system. In a first alternative, several or all of the compressors of the compressor arrangement are connected to a common cooling circuit. This makes it particularly easy, using the initially actuated compressors, to bring the cooling system to temperature for the compressors to be connected in somewhat later. In a further alternative, the cooling system has dedicated cooling circuits for several or all of the compressors, each cooling circuit being provided with individual temperature control, for example by way of a thermostat. The common aim of both alternatives is to first bring the compressors to operating temperature before they are actuated, so that cold starting is avoided as far as possible.

The compressors of the compressor arrangement are preferably each provided with an air bearing arrangement that is configured to ensure substantially wear-free mounting of the compressors when a predetermined lift-off speed is reached or exceeded. Several or all of the compressors of the compressor arrangement are preferably connected to one or more bypass pressure circuits in a fluid-channeling manner, which one or more bypass pressure circuits is or are in turn connected to the bearing gaps of the air bearing arrangements of the compressors in a fluid-channeling manner. These bypasses then make it possible to blow provided compressed air into the bearing gaps of the compressors in a targeted manner as soon as a first compressor or a first number of compressors are actuated during operation and are able to supply pressurized air to the bypass.

The control unit is preferably connected to a communication system of the vehicle in a signal-carrying manner, either directly or indirectly, for example via a bus system, wherein the communication system is for example connected to one or more electronic control units of the vehicle electronics or a fleet management system in a signal-carrying manner. The control unit is preferably configured to receive and process representative data for comparison with the control parameters and, if necessary, to read these data from a data memory or to store them therein.

The control unit may be a dedicated control unit for a compressor, or for the compressor arrangement. As an alternative, the control unit may be a fuel cell control unit. Furthermore, the control unit may, as an alternative, be a stand-alone control unit only for coordinating the compressor arrangement. The control unit may, as an alternative, also be implemented as a module in other control units in the form of hardware or software, for instance in a compressor control unit, in the fuel cell controller, or a brake control unit. In other words, the control unit may also be configured as such an aforementioned unit.

The control unit is configured to carry out the method according to one of the aforementioned embodiments and, to this end, for example, has a data memory in which the commands and, where necessary, control parameters for carrying out the method of the embodiments described above are stored, or is connected to such a data memory, and furthermore preferably has a processor that is configured to carry out the method according to one of the embodiments described above by way of the commands stored in the data memory.

In a further aspect, which is at the same time a sub-aspect of the fuel cell system according to the disclosure and a separate aspect of the disclosure, the disclosure relates to a control unit for a fuel cell system of a utility vehicle, in particular for a fuel cell system according to one of the embodiments described above.

The disclosure achieves the object described at the outset in this regard by virtue of the control unit being configured to carry out the method according to one of the embodiments described above. The control unit is preferably the control unit described above in connection with the fuel cell system. It utilizes the same advantages as the fuel cell system according to the disclosure and the method according to the disclosure.

The embodiments of the method and of the fuel cell system are thus at the same time embodiments of the control unit and vice versa, such that reference is again made to the above explanations in order to avoid repetitions.

In a further aspect, the disclosure furthermore relates to a computer program product for a fuel cell system and/or a control unit according to the aspects described above.

The computer program product achieves the object described at the outset by virtue of containing commands that, when they are executed on a computer, cause the computer to form a control unit according to one of the embodiments described above and/or to carry out the method according to one of the embodiments described above. The computer program product may be present on a computer-readable medium or in downloadable form.

### BRIEF DESCRIPTION OF DRAWINGS

The invention will now be described with reference to the drawings wherein:

FIG. 1 shows a schematic illustration of a utility vehicle according to an embodiment; and,

FIG. 2 shows a schematic illustration of driving so as to operate a fuel cell system of the vehicle according to FIG. 1.

### DETAILED DESCRIPTION

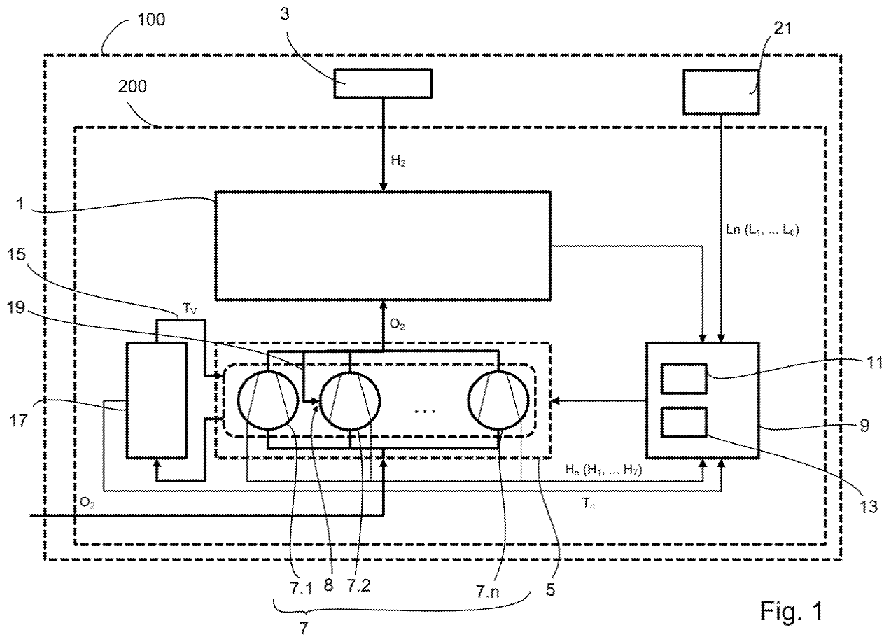

FIG. 1 schematically illustrates a utility vehicle 100 that has a fuel cell system 200. The fuel cell system 200 has a fuel cell 1 that is connected to a hydrogen supply 3 of the utility vehicle 100 in a fluid-channeling manner on the anode side and from which hydrogen (H₂) is supplied to the fuel cell 1. The fuel cell may have one or more stacks (not illustrated).

For the cathode-side oxygen supply (O₂), the fuel cell 1 is connected to a compressor arrangement 5 in a fluid-channeling manner. The compressor arrangement 5 has a plurality of compressors 7.1, 7.2 . . . 7.n, each of which is configured to compress externally supplied air and provide it to the fuel cell 1 in pressurized form. The reference O₂ for oxygen is given by way of example for the supplied air. However, it is in no way mandatory to supply pure oxygen, but rather it is entirely possible and conventional to supply a mixture of substances such as for instance ambient air, which may contain variable proportions of nitrogen, carbon dioxide, noble gases and other gases depending on the environment.

The compressors 7.1 to 7.n are connected in parallel and may be operated individually, in groups or as a whole.

To actuate the compressor arrangement 5, the fuel cell system 200 has a control unit 9. The control unit 9 may be a dedicated control unit, or be assigned in the form of hardware or software to another structural unit, for example the fuel cell 1, for instance as part of the fuel cell control system, or the compressor arrangement 5, and then as part of the compressor control system.

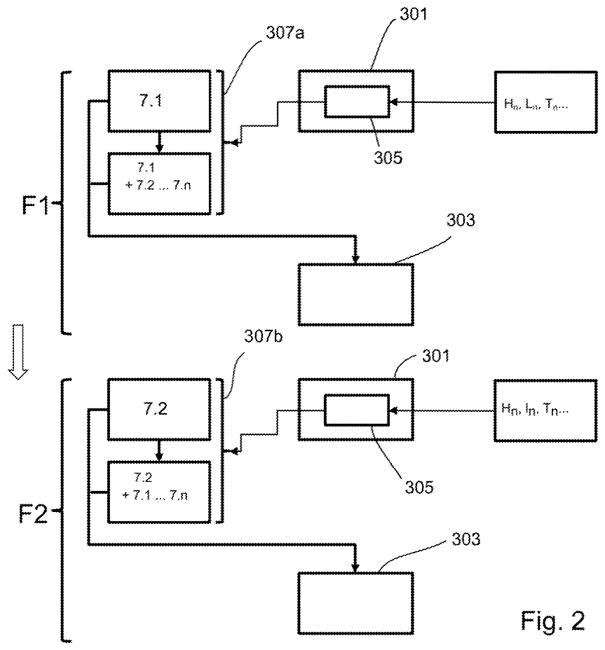

The control unit 9 is connected to the compressor arrangement 5 in a signal-carrying manner and is configured to actuate the compressors 7.1 to 7.n individually, in groups or together and to make a corresponding selection for this actuation in accordance with the method according to one of the embodiments described above, this being explained by way of example below with reference to FIG. 2.

The control unit preferably has a data memory 11 or an interface (not illustrated) to such a data memory, and a processor 13. The data memory 11 preferably stores one or more control parameters Hₙ; Tₙ; Lₙ; and/or commands for carrying out the method according to FIG. 2, and the processor 13 is configured to process the information stored in the data memory 11 and thereby carry out the method according to FIG. 2.

The compressor arrangement 5 is furthermore preferably connected, via a cooling system 15, to a cooling and/or heating device 17 that is configured to bring the compressors 7 of the compressor arrangement 5 into a predetermined temperature range and to keep them there. An embodiment having a single cooling circuit that includes all of the compressors 7.1-7.n is shown. However, according to the disclosure, systems having smaller cooling circuits that each include only one or a few compressors and are able to be actuated separately are also conceivable.

Within the compressor arrangement 5, one, several or all of the compressors 7.1 to 7.n are provided in each case with a bypass 19 that is arranged in each case on the outlet side of the compressor 7 and is configured to branch off a partial flow of the compressed, pressurized air and supply it to an air bearing arrangement 8 of a respective other compressor of the compressors 7 in order to support the lift-off of the rotor shaft of the respective compressor thus blown at and to reduce wear. As an alternative, it is possible to use systems that access an external compressed air supply to support the air bearing arrangement of the compressors 7.1 to 7.n. However, the pressure supply for each bypass 19 is considered to be advantageous in terms of configuration and synergy.

The compressor arrangement 5, and in particular the individual compressors 7.1-7.n, is or are preferably connected to the control unit 9 in a signal-carrying manner and configured to transmit historical data Hₙ from the compressors 7 from the compressor arrangement 5 to the control unit 9, where they may then be stored as control parameters in the data memory 11 and processed by the processor 13. The historical data preferably include one, several or all of the following types of information: accumulated operating time of the compressors H₁, accumulated number of start-up cycles of the compressors H₂, accumulated number of compressor shaft rotations of the compressors H₃, time of last previous commissioning of the compressors H₄, ambient temperature in previous actuations H₅, number of load changes in previous actuations H₆, accumulated operating time of the compressors in the upper load range H₇, or a combination of several or all of the above parameters.

It is possible, within the context of the disclosure, to record in each case the complete data cycle of the historical data Hₙ and/or performance data L n in the data memory 11 and to evaluate these at start-up.

In order to reduce the need for memory space and computing power, in one embodiment, it is proposed to provide the data in a ring memory that contains only a limited number of previous actuations and in particular is repeatedly overwritten.

For a ring memory system, each of the compressors 7.n is preferably assigned an initially initialized service life of for example 35,000 operating hours in which the compressor 7.n must be able to complete a predetermined number, for instance 200,000, of start-stop cycles. These two values are preferably reduced by subtraction over time as a function of actuations during the journeys undertaken, until the compressor 7.n has reached its wear limit.

The method according to the disclosure is used to configure the reduction of both characteristic values to be as equal as possible across all compressors 7.n, as explained above.

In an embodiment, the historical data and performance data are each assigned influencing factors that are representative of the impairment of the service life and of the value of the start-stop cycles performed. The influencing factors are furthermore preferably compiled to form a cost function or penalty function. This function modifies the value that is subtracted from the score of the compressor 7.n when the compressor is actuated, the value starting from a standard value that has been determined in advance under controlled conditions. This is explained with reference to an example:

The above initial compressor state (35,000 remaining operating hours, 200,000 remaining start-stop cycles) is reduced by 2 hours and 6 cycles after initial commissioning: 35,000 h-2 h & 200,000 S/S-6 S/S.

The initial state of the compressor in the ring memory is overwritten with the current value 34,998 h and 199,994. This value is compared with the memory values of the other compressors at the next start-up. Only small amounts of data therefore need to be stored and compared.

As cost function or penalty function, the value of these subtractions may then be modified on the basis of the historical data Hₙ and/or performance data Lₙ, for example as a function of the temperature data. If the compressor is started at a low temperature, for instance −10° C., a 10%-higher value is subtracted from the remaining overall number as an indicator of a greater load per start, a 20%-higher value is subtracted at −20° C., et cetera. It is then not “1” that is subtracted from the initial value stored in the ring memory upon actuation, but rather “1.1”, et cetera.

The load change information from the performance data is explained as a further example: A reasonable load change under controlled conditions is set as a metric, for example a change from 30% to 100% power within a period of 10 seconds. If faster regulation is necessary or a higher power step, it is also possible here for example to subtract an additional 10% for each second for which the load change takes place more quickly, or 10% for each power step that is higher than that prescribed.

In a further example, the influence of the operating hours information from the historical data Hₙ is explained in connection with the speed information from the performance data Lₙ. By way of example, one hour of service life in laboratory operation with a specified nominal speed of for example 80,000 revolutions is defined as a metric. If the compressor 7.n is rotated faster over longer periods of time, the value to be subtracted is likewise increased, for instance by in each case 0.1 hours more for each 5000 revolutions more over one operating hour.

Further and different programming-based implementations are likewise possible, using which load-appropriate tracking of the continuing wear of the compressors 7.n is achieved.

The cooling system 17 is preferably connected to the control unit 9 in a signal-carrying manner and is configured to transmit temperature data Tₙ to the control unit 9 that are representative of the operating temperature T_{V} of the cooling system 17 and are stored as control parameters in the data memory 11 and are able to be processed by the processor 13.

The utility vehicle 100 preferably has a communication system 21 that may have a bus architecture, not illustrated in any more detail, and one or more control units and computer systems that are in turn connected to further parts, not illustrated in any more detail, of the vehicle electronics, for instance data memories or sensors, of the utility vehicle 100 in a signal-carrying manner in order to collect and process operating information and state information in relation to the utility vehicle 100.

The communication system 21 may for example be connected to a fleet management system, an air suspension system, a braking system and the like of the utility vehicle 100. The communication system 21 is preferably connected to the control unit 9 in a signal-carrying manner and is configured to send performance data L n to the control unit that are representative of one, several or all of the following types of information: optimum operating point of the compressors L₁, mass of the utility vehicle L₂, route length of the journeys L₃, route topography of the journeys L₄, total storage capacity of the electrical storage unit of the utility vehicle 100 L₅, state of charge of the electrical storage unit of the utility vehicle 100 L₆, or a combination of several or all of the above parameters.

This information is preferably stored in the data memory 11 of the control unit 9 as control parameters and is processed by the processor 13 in order to perform the method. The method according to the disclosure according to FIG. 2 is described in more detail below.

FIG. 2 illustrates, by way of example, two consecutive journeys F1, F2 for the operation of a utility vehicle 100 according to FIG. 1. The journeys generally include a step 301 of actuating the compressor arrangement 5 such that pressurized air is provided, and a step 303 of supplying the pressurized air to the fuel cell system 200 of the utility vehicle 100.

Step 301 further includes a step 305 of selecting a number and/or sequence of compressors 7.1 to 7.n from the plurality of compressors 7 to be actuated for the respective journey F1 or F2, such that a number and/or sequence 307a, 307b differs at least for two consecutive journeys (F1;F2) of the utility vehicle 100. In the first journey F1, a first number and/or sequence 307a is selected, for example by way of the control unit 9, and are initially intended to be provided for the purpose of providing pressurized air. By way of example, this is the compressor 7.1 for the journey F1. The selection may for example be made deterministically, for instance based on a predefined cyclic sequence of the compressors 7.1-7.n or based on a random generator, for instance during the first journey, in which for example the in each case last selected compressors are blocked for the respective following random selection.

As an alternative or in addition, the selection step may also take place on the basis of one or more control parameters Hₙ; Tₙ, Lₙ.

In the present embodiment, a sequence has been selected for the journey F1 in step 305 in which initially only the compressor 7.1 is actuated, and a second compressor 7.2 is additionally actuated at a later time in order to provide pressurized air. By way of example, the first compressor 7.1 may therefore be selected because it has a low elapsed service life compared to the other compressors, which is apparent from the historical data Hₙ.

The additional actuation of the second compressor 7.2 may for example result, in selection step 305, from the fact that the second compressor 7.2 has reached its operating temperature T_{V} at a certain time, which is apparent from the temperature data Tₙ, in order to further reduce the wear of those compressors that are not actuated first in a selection sequence, by heating them to operating temperature even before they are started, and it is possible to avoid a cold start for these compressors.

As an alternative or in addition, one or more additional compressors 7.2-7.n may be actuated if it is apparent from the performance data L n that there are certain performance requirements for the journey F1 at a certain time, for example due to the route topography, route length and the like.

For the second journey F2 following the first journey F1, a step 305 of selecting a number and/or sequence 307b of compressors 7.1 . . . 7.n from the plurality of compressors 7 takes place again, wherein, for the journey F2, at least the number of compressors differs from journey F1 in that it is not the compressor 7.1 that is actuated first, but rather another compressor, namely the compressor 7.2.

If it is necessary to subsequently actuate one or more further compressors from the compressor arrangement 5, in the journey F2, as an alternative or in addition, it is possible to actuate a sequence of further compressors different from the journey F1, for example first the compressor 7.2 and, at a later time, additionally the compressor 7.1 or one or more further compressors from the plurality of compressors 7.

The control parameters Hₙ, Lₙ, Tₙ are preferably updated in intervals or continuously during the journeys F1, F2 and stored in the data memory 11 of the control unit 9, and taken into consideration accordingly for the selection routine of future journeys.

Compressors 7.1 . . . 7.n, once actuated and therefore running, are preferably not deactivated again before the end of the respective journey F1, F2 as long as they are able to operate at an acceptable operating point in order to minimize wear caused by runout at reduced speed as far as possible.

By taking into consideration the control parameters Hₙ, Lₙ, Tₙ, the control unit is able to carry out the method according to the disclosure such that, for each journey F1, F2, only the minimum required number of compressors 7.1 to 7.n is ever actuated, and all of the compressors 7.1 . . . 7.n are loaded as evenly as possible across multiple journeys F1, F2, so that the maintenance interval of the fuel cell system 200 as a whole is maximized as far as possible.

It is understood that the foregoing description is that of the preferred embodiments of the invention and that various changes and modifications may be made thereto without departing from the spirit and scope of the invention as defined in the appended claims.
1 Fuel cell
3 Hydrogen supply
5 Compressor arrangement
7, 7.1,7.-2,7.n Compressors
8 Air bearing arrangement
9 Control unit
11 Data memory
13 Processor
15 Cooling system
17 Cooling and/or heating device
19 Bypass
100 Utility vehicle
200 Fuel cell system
301 Step, actuating the compressor arrangement 5
303 Step, supplying pressurized air to the fuel cell 1
305 Step, selecting
307a, 307b Number and/or sequence of selected compressors 7.1-7.n
F1, F2 Journey of the utility vehicle 100
O₂ Pressurized air
H₂ Hydrogen

### Control Parameters:

H_{N} Historical data:
H₁ Accumulated operating time of the compressors
H₂ Accumulated number of start-up cycles of the compressors
H₃ Accumulated number of compressor shaft rotations of the compressors
H₄ Time of last previous commissioning of the compressors
H₅ Ambient temperature in previous actuations
H₆ Number of load changes in previous actuations
H₇ Accumulated operating time of the compressors in the upper load range
Lₙ Performance data:
L₁ Optimum operating point of the compressors
L₂ Mass of the utility vehicle (100)
L₃ Route length of the journeys (F1, F2)
L₄ Route topography of the journeys (F1, F2)
L₅ Total storage capacity of electrical energy storage unit of the utility vehicle (100)
L₆ State of charge of electrical storage unit of the utility vehicle (100)
Tₙ Temperature data:
T_{V} Operating temperature cooling system

1. A method for operating a fuel cell system of a utility vehicle over multiple journeys, the method comprising:
actuating a compressor arrangement having a plurality of compressors such that pressurized air is provided;
supplying the pressurized air to the fuel cell system on a cathode side; and,
wherein said actuating the compressor arrangement includes selecting at least one of a number and a sequence of compressors from the plurality of compressors to be actuated for the journeys such that said selecting at least one of the number and the sequence differs at least for two consecutive journeys of the utility vehicle.

2. The method of claim 1, wherein the at least one of the number and the sequence of the selected compressors always differs for two consecutive journeys of the utility vehicle.

3. The method of claim 1 further comprising retrieving one or more control parameters stored in a data memory; and, said selecting being done on a basis of the one or more control parameters.

4. The method of claim 3, wherein the one or more control parameters include historical data from the compressor in the compressor arrangement.

5. The method of claim 4, wherein the historical data represent at least one of:
accumulated operating time of the compressors;
accumulated number of start-up cycles of the compressors;
accumulated number of compressor shaft rotations of the compressors;
time of last previous commissioning of the compressors;
ambient temperature in previous actuations;
number of load changes in previous actuations; and,
accumulated operating time of the compressors in the upper load range

6. The method of claim 3, wherein the one or more control parameters include performance data that represent at least one of:
optimum operating point of the compressors;
mass of the utility vehicle;
route length of the journeys;
route topography of the journeys;
total storage capacity of the electrical storage unit of the utility vehicle;
state of charge of the electrical storage unit of the utility vehicle; and,
a combination of several or all of the above parameters.

7. The method of claim 3, wherein the one or more control parameters include temperature data.

8. The method of claim 7, wherein the temperature data represents information about an operating temperature of a cooling system of the compressors.

9. The method of claim 1, wherein a first number of compressors is actuated at the start of a journey.

10. The method of claim 1, wherein a single compressor is actuated at the start of a journey.

11. The method of claim 9, wherein one or more further compressors are additionally actuated during the journey.

12. The method of claim 9, wherein one or more further compressors are additionally actuated during the journey on a basis of one or more of control parameters.

13. The method of claim 9, wherein the first number of the compressors actuated at the start of each journey differ in consecutive journeys.

14. The method of claim 11, wherein at least some of the air compressed by the first number of compressors is supplied to an air bearing arrangement of one or more of the further compressors.

15. The method of claim 1 further comprising continuing to actuate the compressors during the journeys, even if an amount of compressed air required by the fuel cell system decreases.

16. The method of claim 15, wherein said actuation of the compressors is continued as long as an efficiency of a respective operational arrangement including compressor, electric motor and power electronics remains above a predetermined threshold value.

17. The method of claim 15, wherein said actuation of the compressors is continued as long as an efficiency of a respective operational arrangement including compressor, electric motor and inverter remains above a predetermined threshold value.

18. A fuel cell system of a utility vehicle, the fuel cell system comprising
a fuel cell;
a compressor arrangement connected to said fuel cell in a fluid-conducting manner;
said compressor arrangement having a plurality of compressors and being configured to provide pressurized air to said fuel cell on a cathode side;
a control unit connected to said compressor arrangement in a signal-carrying manner and configured to actuate said plurality of compressors of said compressor arrangement;
said control unit being configured to:
actuate said compressor arrangement such that pressurized air is provided;
supply the pressurized air to said fuel cell system on a cathode side; and,
wherein the actuating the compressor arrangement includes selecting at least one of a number and a sequence of compressors from said plurality of compressors to be actuated for the journeys such that the selecting at least one of the number and the sequence differs at least for two consecutive journeys of the utility vehicle.

19. A control unit for a fuel cell system of a utility vehicle, wherein the control unit is configured to carry out the method of claim 1.

20. The control unit of claim 19, wherein the fuel cell system includes:
a fuel cell;
a compressor arrangement connected to said fuel cell in a fluid-conducting manner;
said compressor arrangement having a plurality of compressors and being configured to provide pressurized air to said fuel cell on a cathode side;
a control unit connected to said compressor arrangement in a signal-carrying manner and configured to actuate said plurality of compressors of said compressor arrangement;
said control unit being configured to:
actuate said compressor arrangement such that pressurized air is provided;
supply the pressurized air to said fuel cell system on a cathode side; and,
wherein the actuating the compressor arrangement includes selecting at least one of a number and a sequence of compressors from said plurality of compressors to be actuated for the journeys such that the selecting at least one of the number and the sequence differs at least for two consecutive journeys of the utility vehicle.

21. A computer program product stored on a non-transitory computer readable medium, the computer program product including commands that, when executed by a computer, cause the computer to form the control unit of claim 19.

22. A computer program product stored on a non-transitory computer readable medium, the computer program product including commands that, when executed by a computer, cause the computer to carry out the method of claim 1.
